(19) United States
(12) Patent Application Publication
(10) Pub. No.: US 2026/0357493 A1
(43) Pub. Date: Nov. 12, 2026

(54) SEAM RIPPER WITH PETALS

(71) Applicant: The Questioning Quilter LLC, Berwyn, PA (US)

(72) Inventors: David Everett Satzman, Berwyn, PA (US); Brita Joanne Nelson, Berwyn, PA (US)

(21) Appl. No.: 19/670,715

(22) Filed: May 7, 2026

Related U.S. Application Data
(60) Provisional application No. 63/803,612, filed on May 10, 2025.

(51) Int. Cl. D05B 89/00; B26B 25/00

(52) U.S. Cl. CPC D05B 89/00; B26B 25/005

(57) ABSTRACT

This seam ripper is designed for sewers and quilters and includes, in one embodiment, a vertically mounted rotary cutter blade in a round holder shaped like a flower. The apparatus has protrusions (petals), which may have a curve in the plane of the blade, and a taper in the perpendicular axis. The petals simultaneously part the fabric as it advances down the taper, as well as aligning the fabric to guide the seam toward the blade at an advantageous angle, while keeping the fabric away from the sharp edge. The apparatus’s orientation, standing positioned upright, allows use of both hands on the fabric. This allows the user to apply even pressure helping to keep the fabric pieces aligned allowing for a long “rip” (cutting through several stitches) on each pull of the fabric.

### RELATED APPLICATION

This Application claims the benefit under 35 U.S.C. § 111(e) of the Provisional U.S. Patent Application having serial No. 63/803,612 (titled “SEAM RIPPER USING A ROTARY CUTTER BLADE”) filed on May 10, 2025, the entire contents and teachings of which are hereby incorporated herein by this reference.

### FIELD OF THE DISCLOSURE

The present disclosure relates to an apparatus for cutting or ripping seams.

### BACKGROUND

Since people started sewing, there has always been a need to “unsew” a seam using a sharp blade. This is true of all sewing types, but quilters, in particular, have a great need for this device. Quilters spend a good deal of time sewing small pieces of fabric together to form blocks and these are then sewn together to make more complicated and beautiful designs. Quite often though, fabrics are sewn together incorrectly and these pieces need to be separated from each other easily and quickly. This requires a sharp blade and a design to bring the seam to the blade, and often a way to separate the two pieces of fabric a little bit to help prevent cutting of the fabric instead of the seam. A good, sharp, well-designed ripper will allow for the cutting/ripping of multiple stitches at a time. Unfortunately, all blades become dull. When this happens, the user will have to either use more force and risk cutting the fabric or pick the seams one at a time and eventually need to buy an entirely new seam ripper.

Seam rippers have been around for over 100 years using a variety of blade shapes. The earliest versions were simply handles to hold razor blades. Blades have evolved from straight blades, to angled blades, to hooked blades to the “U” shaped blade used in the ubiquitous modern seam ripper. All of these designs have handles and require the seam ripper to be held in one hand and the fabric to be held in the other. The modern seam ripper has a U-shaped cutting edge recessed at the base of a larger U-shaped fabric guide. The two edges of the U are very narrow and fit between the two pieces of fabric to be separated.

### SUMMARY

One major drawback of all seam rippers is that the blades eventually become dull. A dull blade reduces the cutting to one stitch at a time, causes the user to use more force, possibly ripping the fabric and eventually having to purchase an entirely new seam ripper. There is a need for a new type of seam ripper with multiple cutting surfaces and a replaceable blade.

Round Pendant style thread cutters using round blades have been around since Victorian times, and reproductions of this are still available for sale. None of the seam rippers to date have made use of a round cutting blade.

Thread cutters and seam rippers are dramatically different tools though. One issue with the thread cutters is that they are designed to cut one or two threads at a time, either for finishing a hand sewing project or separating quilted blocks that are “chain pieced”. Chain piecing is a method of sewing multiple separate pieces of fabric together without cutting the threads until after several of them have been sewn. There is a length of thread between the sewn pieces which needs to be cut before the quilter can move to the next step in the process. One of the key requirements to use a thread cutter is that there be a length of thread to be cut. Thread cutters are not designed to open seams or to cut multiple stitches at one time, as they lack any way to guide the seam to the blade or separate the two pieces of fabric from one another. Additionally, seam rippers work best with a sharp blade, as opposed to thread cutters which can function with a much duller, or even a used blade. Using a rotary cutter blade in shaped holder as a seam ripper is new, novel, and unintuitive.

Embodiments according to the present disclosure include a round (flower shaped) holder with protrusions, referred to here as petals, a stand, and a sharp, rotary cutter blade to be used as a seam ripper. The larger piece of the holder has multiple petal shaped lobes extending past the edge of the blade. The edge of the blade is revealed in a gap between the petals. One important part of this apparatus is the geometry of the petals. There are angles/curves in two different axes. The first angle starts with the top of the petal being very thin so that it easily goes between the two pieces of fabric to be separated. This taper facilitates the parting of the two pieces of fabric, exposing the seam to the blade. The second is the curve of the lobe/petal coming to the gap. This is to ensure that the seam meets the blade in the best orientation. Because this seam ripper may be held upright in a stand, both hands can be used to guide the fabric. With one hand on each side, holding each of the two pieces of fabric, even pressure can be used when pulling the seam into the blade. The fabric is less likely to be cut accidentally when handled with two hands. This is opposed to the traditional seam ripper, which requires the user to hold the device in one hand, and the fabric in the other.

In order to always have a very sharp edge for ripping, there are multiple petals creating, in effect, multiple seam rippers in one device. The smaller piece (cap with push in fastener) of the holder allows access to the side of the blade, so that when all the exposed blade sections become dull, the user can rotate the blade to expose an unused part of the blade to those gaps. The multiple gaps and ability to expose fresh cutting edges promotes the longevity of the useful life of the blade.

This device separates, allowing the blade to be changed out when it gets dull. This means that the user will not need to buy an entirely new seam ripper, as is currently the case, because the blade itself can easily be removed from the device and replaced.

In one embodiment, an apparatus is described. The apparatus includes (a) two tapered petals, each tapered petal having a tapered thickness that increases from a peripheral edge towards an interior point; (b) a gap between the two tapered petals; and (c) a blade having a cutting edge that protrudes into the gap. (d) A side wall of each of the two petals adjacent to the gap is substantially perpendicular to the cutting edge of the blade.

In some embodiments, the side wall of each of the two petals adjacent to the gap is shaped such that the gap widens between the edge of the blade and the peripheral edges of the two petals. In some of these embodiments, the side walls of each of the two petals adjacent to the gap curve away from each other, the two tapered petals each having a rounded shape.

In some embodiments, the gap decreases in width beyond the edge of the blade such that the two petals connect to form a single blade holder piece, the blade holder piece including an indentation in which the blade rests. In some of these embodiments, the single blade holder piece includes a plurality of more than 2 tapered petals and a plurality of more than 1 gap between adjacent petals, the edge of the blade protruding into each gap.

In some of these embodiments, (1) the single blade holder piece includes a central portion having a substantially circular shape, each of the plurality of more than 2 tapered petals emanating from the central portion having the substantially circular shape; (2) the blade is a circular blade and the cutting edge is circular around a circumference of the blade; and (3) the indentation in which the blade rests is circular in shape, situated within the central portion of the single blade holder piece. In some of these embodiments, the circular blade is fastened to the single blade holder piece such that the circular blade is fixed into place within the indentation; and the circular blade can be rotated within the indentation with the application of more than a threshold amount of force.

In some of these embodiments, the circular blade includes a plurality of markings adjacent to its cutting edge to indicate how much the circular blade has been rotated. In some of these embodiments, two or more of the plurality of markings are numbered in consecutive order. In some of these embodiments, the plurality of markings includes unnumbered markings, one unnumbered marking interposing halfway between each pair of consecutively numbered markings.

In some embodiments, a count of the numbered markings is a natural number multiple of the plurality of gaps.

In one embodiment, a method of operating one of the apparatuses described above is described. The method includes, in response to a portion of the cutting edge of the blade protruding into one of the plurality of gaps becoming dull, applying more than the threshold amount of force to the blade and rotating it such that a sharp portion of the cutting edge is exposed protruding into the one of the plurality of gaps.

In one embodiment, a system is described. The system includes (I) one of the apparatuses described above and (II) a base portion having a slit into which one or more of the plurality of petals of the apparatus may be inserted. (III) One or more of the plurality of petals of the apparatus is inserted into the slit of the base portion and the base portion is resting on a surface, so that the apparatus is mounted upright within the base portion with respect to the surface.

In some embodiments, the base portion includes a top piece and a bottom piece, the slit being situated in the top piece, the top piece and the bottom piece being separable to allow the apparatus to be stored within a compartment formed from the top piece and the bottom piece once the top piece and the bottom piece are reattached.

In some embodiments, the base portion includes a knurled edge for gripping.

In some embodiments, the base portion includes a plurality of feet made from a substance having traction positioned opposite the slit, allowing the base portion to firmly grip the surface.

In one embodiment, a method of ripping a seam attaching two pieces of fabric using one of the systems described above is described. The method includes (i) placing the base portion on the surface; (ii) inserting one or more of the plurality of petals of the apparatus into the slit of the base portion to mount the apparatus in an upright position; (iii) holding a first piece of the two pieces of fabric with a first hand and a second piece of the two pieces of fabric with a second hand and positioning the first piece of fabric adjacent to the back piece of the apparatus and the second piece of fabric adjacent to the fastening mechanism with one end of the seam situated in one of the gaps between the petals of the apparatus; and (iv) pulling down the two pieces of fabric with the first hand and the second hand to guide the seam into the cutting edge protruding into the one of the gaps, causing the seam to be cut and to separate the two pieces of fabric, a petal of the apparatus guiding the two pieces of fabric as the two pieces of fabric are pulled down.

In another embodiment, a method of ripping a seam attaching two pieces of fabric using one of the apparatuses described above is described. The method includes (A) holding both of the two pieces of fabric with a first hand; (B) holding the apparatus with a second hand, the apparatus being positioned between the two pieces of fabric such that one end of the seam is situated in one of the gaps between the petals of the apparatus; and (C) pulling the apparatus with the second hand to guide the seam into the cutting edge protruding into the one of the gaps, causing the seam to be cut and to separate the two pieces of fabric, a petal of the apparatus guiding the apparatus to stay between the two pieces of fabric.

In some embodiments, the seam ripper is kept upright by fitting into a box. One embodiment uses a slit in the lid of the box to hold the ripper. The thickness of the lid should be enough to hold the ripper snugly and in an upright position without pivoting. The height of the inside compartment should be enough such that the petals/lobes rest on the bottom of the box, or just above it, lest the tool protrude too far from its slot. In some embodiments the device can be stored in the base.

### BRIEF DESCRIPTION OF THE DRAWINGS

The foregoing and other objects, features, and advantages will be apparent from the following description of particular embodiments, as illustrated in the accompanying drawings in which like reference characters refer to the same parts throughout the different views. The drawings are not necessarily to scale, emphasis instead being placed upon illustrating the principles of various embodiments of the invention.

FIG. 1 illustrates an example set of pieces for use in connection with one or more embodiments.

FIG. 2 illustrates an example piece for use in connection with one or more embodiments.

FIG. 3 depicts another view of the piece from FIG. 2.

FIG. 4A depicts one view of an example apparatus according to one or more embodiments made up of a subset of the pieces depicted in FIG. 1.

FIG. 4B depicts an exploded view of the example apparatus of FIG. 4A.

FIG. 5 depicts one view of an example system according to one or more embodiments made up of the apparatus depicted in FIG. 4A and another example apparatus made up of another subset of the pieces depicted in FIG. 1.

FIG. 6 illustrates one view of another example piece for use in connection with one or more embodiments.

FIG. 7 depicts another view of the example piece depicted in FIG. 6.

FIG. 8 depicts another view of the other example apparatus depicted in FIG. 5.

FIG. 9 depicts an exploded view of the example apparatus depicted in FIG. 4A being inserted inside of the other example apparatus depicted in FIG. 7.

FIG. 10 depicts an example view of the example system depicted in FIG. 5 in use.

FIG. 11 depicts an example view of the example apparatus depicted in FIG. 4A in use.

FIG. 12 depicts an example method of using the example system depicted in FIG. 5.

FIG. 13 depicts an example method of using the example apparatus depicted in FIG. 4A in accordance with one or more embodiments.

FIG. 14 depicts another example apparatus according to one or more embodiments.

FIG. 15 depicts an alternative feature according to an example embodiment.

### DETAILED DESCRIPTION

Examples of the methods, apparatuses, and systems discussed herein are not limited in application to the details of construction and the arrangement of components set forth in the following description or illustrated in the accompanying drawings. The methods, apparatuses, and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

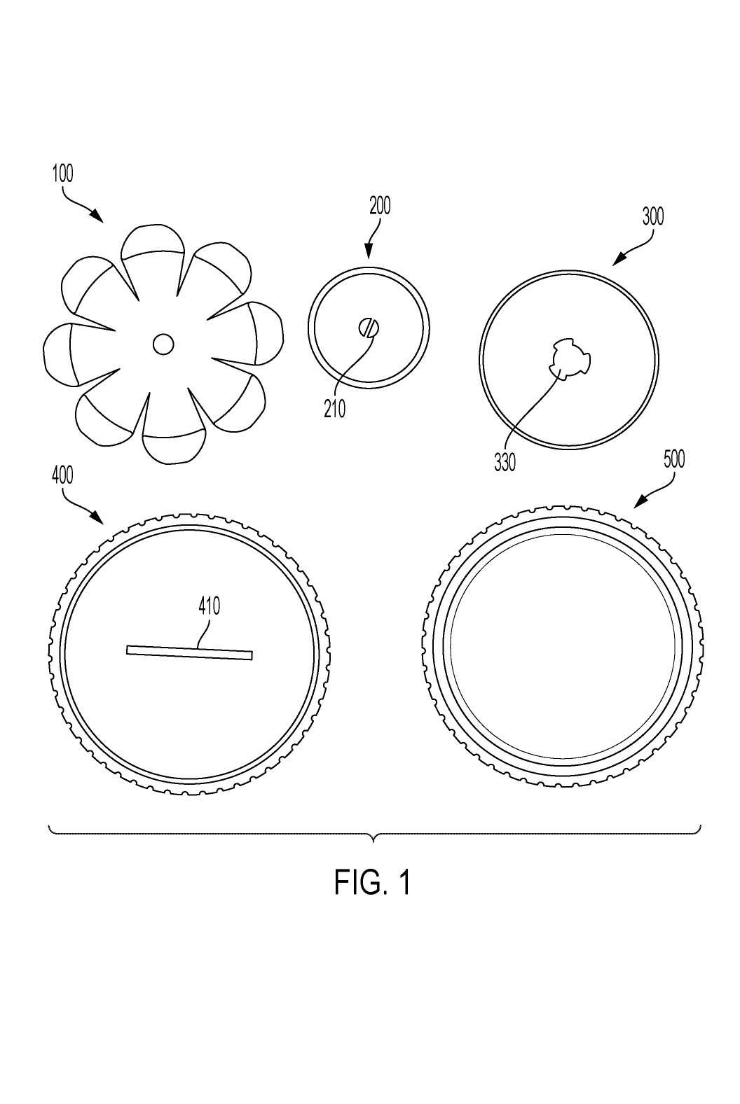

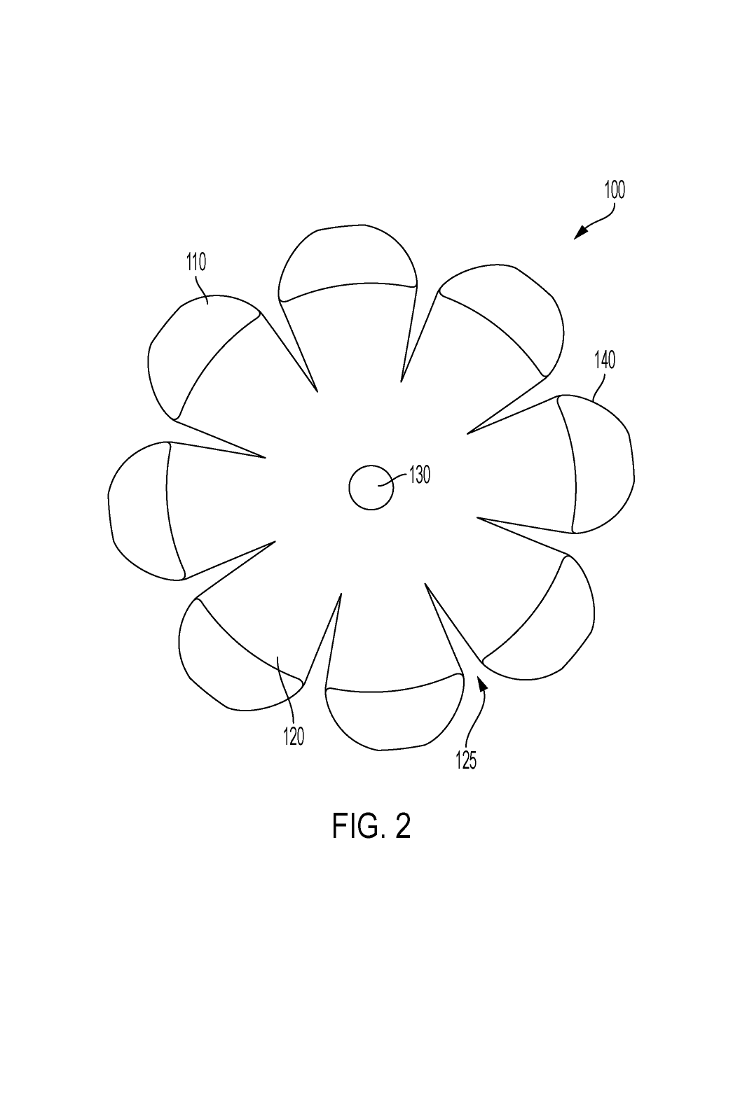

FIG. 1 shows all 5 pieces of an apparatus and system according to an example embodiment. Items 100 and 200 are the front and back of the blade holder. The back 100 is the part with the lobes/petals and is described in more detail in connection with FIG. 2. The front 200 is a cap including a disk with a push-in fastener for connecting the front and back and securing the blade 300 in between. In some embodiments, another kind of connector could be used here, such as, for example, a magnetic connector. Because of the design, a single new blade should last for considerable time, meaning that the blade 300 won’t need to be replaced very often, but it can be replaced when needed. Item 300 is a new rotary cutter blade with a sharp edge.

Items 400 and 500 are the top and bottom of a simple, round, threaded box with a slit in the lid. In an embodiment, the slit 410 conforms very closely to the size of the ripper to ensure that the ripper stays firmly in place during use. The lid 400 of the box should ideally be of sufficient thickness such that the ripper will be well supported in the slot and not move/rock front to back. The depth of the compartment should be enough such that the apparatus sits fully in the slot. The sides of the box have a knurled design to make the box easy to grip.

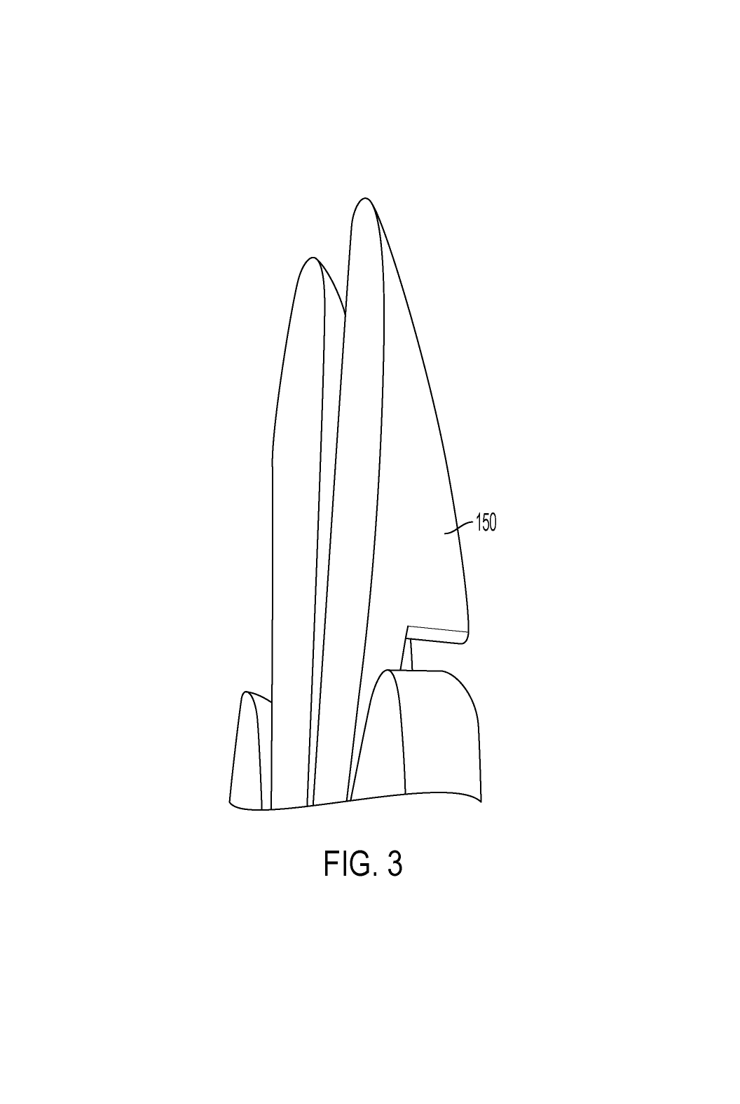

FIG. 2 shows the details of one aspect of the apparatus 100 according to one embodiment. This is the back part of the blade holder. It has multiple lobes/petals 110 and looks something like a flower. Part of each petal 110 extends above the edge of the blade 300 and protects the user’s fingers from getting cut. The shape (i.e., curve 140 and taper 150, see FIG. 3) of the petal 110 orients the two pieces of fabric and guide the seam to the blade 300. Back 100 includes a recess 120 where the blade 300 will sit. The blade 300 sits deep enough in the recess 120 that the cutting portion 310 of the blade 300 is only accessible between the petals 110 through gap 125. The taper 150 from the periphery of the petal 110 towards the inside helps the narrow end get between two pieces of fabric, and guide them apart. The seam can rest, perched on a somewhat sharp edge at the top of the petal 110. Then the curve 140 of the petal 110 guides the seam down to the blade 300.

There is a hole 130 in the center of the piece 100 to allow the push-in fastener 210 to connect the front to the back, holding the blade 300 in place. In another embodiment, another kind of fastener could be used instead.

FIG. 3 shows a side view of one of the petals 110 highlighting its angular, tapered shape 150. When two pieces of fabric are sewn together, they sit parallel to each other and are held together by the seam. The narrow top part of the petal’s taper 150 slips in between those two pieces of fabric lining up the seam with the blade 300. The thickness of the petal 110 gradually increases, allowing the parted pieces of fabric to be guided perpendicularly to the blade 300. Depending on the embodiment, the thickness of the petal 110 at the top edge may vary between 0.01 and 0.5 millimeters, and the thickness of the petal 110 at its thickest point near the blade 300 may vary between 2 and 5 millimeters, for example.

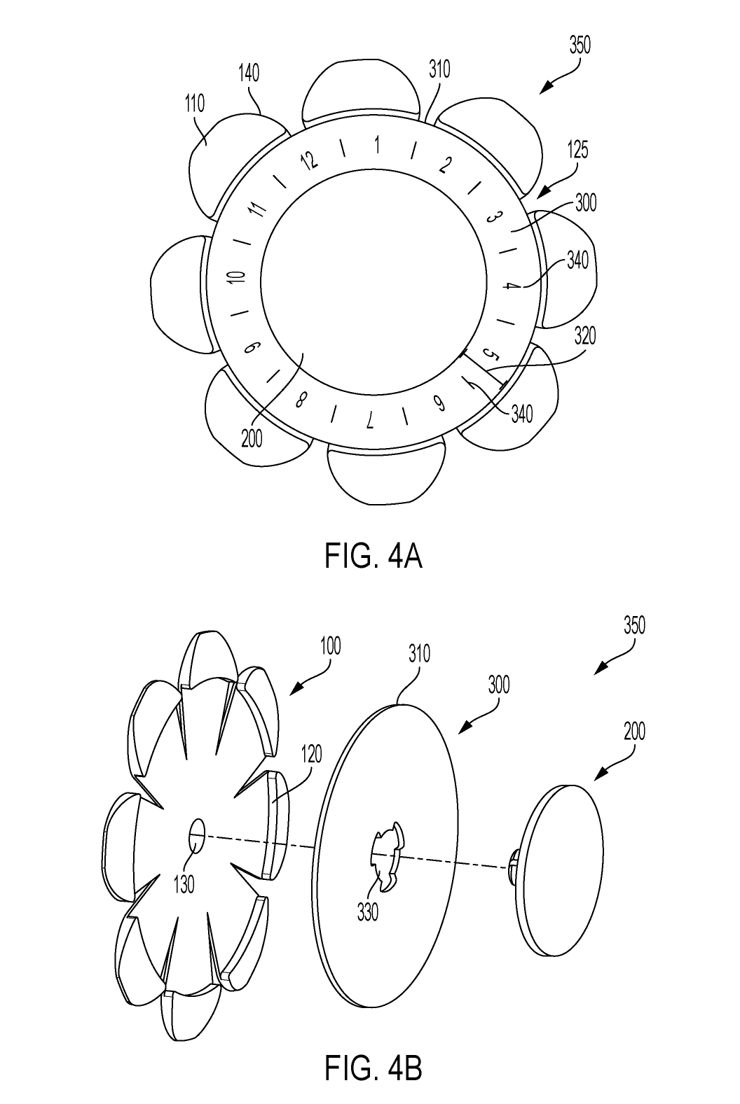

FIG. 4A shows the three pieces of the seam ripper 100, 200, 300 assembled into a blade assembly 350. The rotary cutter blade 300 is placed in the recess 120 of the petal shaped piece 100. As illustrated in the exploded view of FIG. 4B, a hole 330 in the blade 300 will line up with the hole 130 in the petal shaped piece 100. The cap 200 is placed on top with the push-in fastener 210 down. This fastener 210 is pushed through the hole 330 in the blade 300 and into the hole 130 in the back half of the holder 100. This secures the blade 300 in place but still allows it to be manually rotated to expose new, still-sharp portions of the cutting edge 310. At such time as the entire blade 300 becomes dull, the cap 200 can be removed and the blade 300 replaced with a new one.

There is a space 320 on the blade 300 between the edge of the cap 200 and the overlap of the petals 110 (by the edge of the blade 300). The user can then use their finger on the side of the blade 300 to rotate it a small amount to expose a new, sharp portion of the edge 310 of the blade 300 when that becomes necessary. This rotation may be done by the user applying at least a threshold amount of force with their finger to the space on the blade and pushing to the side. The threshold amount of force will vary depending on the configuration; it should be based on how tightly the cap 200 (or other type of fastener) pushes the blade 300 against the petal shaped piece.

Each gap 125 is narrow enough to prevent the user from cutting themselves on the blade 300, but wide enough for the seam to easily reach the cutting edge 310. Curve 140 in the top section of the lobe/petal 110 is used to guide the seam toward the exposed edge of the blade (310).

In some embodiments, blade 300 may include markings 340 within the space 320 around the cutting edge 310. For example, as depicted in FIG. 4A, markings 340 include numbers 1-12 spaced evenly around the circumference of the blade 300 as well as halfway markers in between each pair of numbers for a total of 24 markings 340. In another example embodiment, the number of markings 340 may be an integer multiple of the number of gaps 125. For example, as depicted, there are 8 petals 110 and 8 gaps 125 between the petals 110; thus, there might be 8, 16, 24, 32, 40 . . . markings 340. In one embodiment, the integer multiplier may be based on the ratio of the width of a petal 110 at the cutting edge 310 to the width of the gap 125 at the cutting edge 310 (e.g., an integer multiplier of 4 or 5).

FIG. 4B depicts an exploded view of the blade assembly 350.

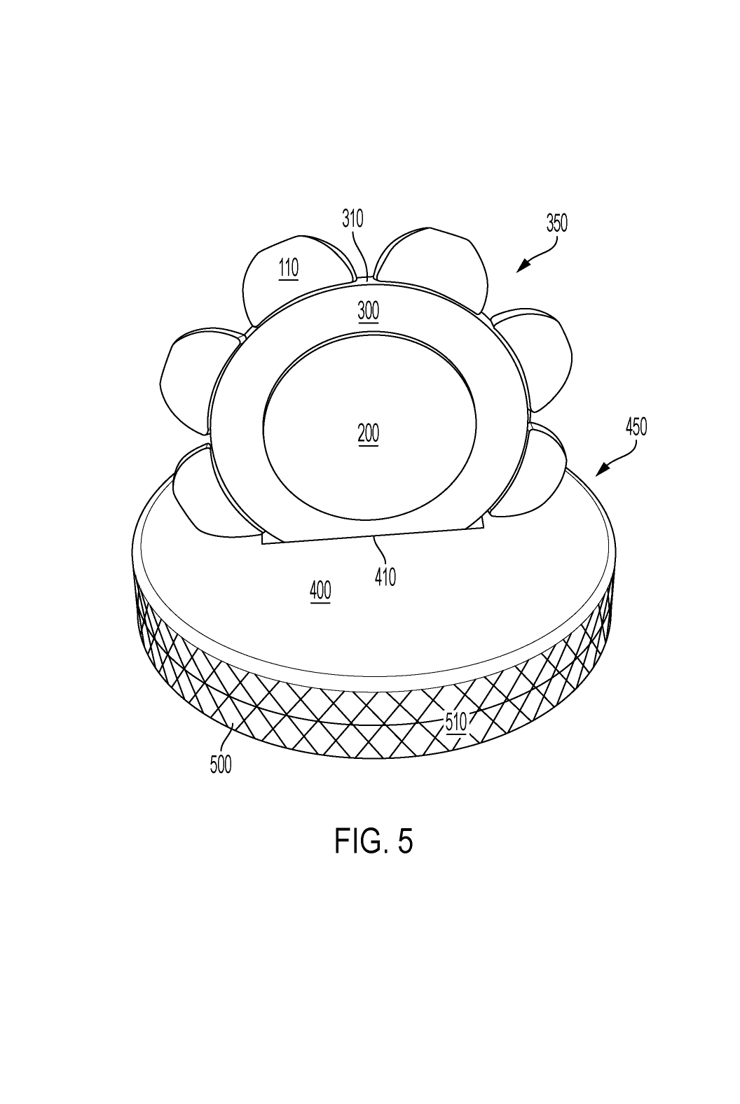

FIG. 5 shows the seam ripper/blade assembly 350 being held upright in a base assembly 450, forming a system. The top 400 and bottom 500 are two pieces of a round threaded box with a slit 410 in the top. In some embodiments, top piece 400 and bottom piece 500 may both included threading (not depicted) that allows the items 400, 500 to screw together into box assembly 450. In other embodiments, top piece 400 and bottom piece 500 may snap together using a snap fastening mechanism or a magnetic closure mechanism. As depicted, the edge 510 of the box/base assembly 450 is knurled to allow for easier gripping. The seam ripper assembly 350 sits firmly in the slit 410 to keep it from wobbling when in use. The height of the inside compartment within the base assembly 450 should be enough such that when the blade assembly 350 is mounted in the slit 410, the petals/lobes 110 rest on the bottom 500 of the base assembly 450, or just above it, lest the tool protrude too far from its slot 410. The seam ripper assembly 350 can be stored in this base assembly 450 when not in use.

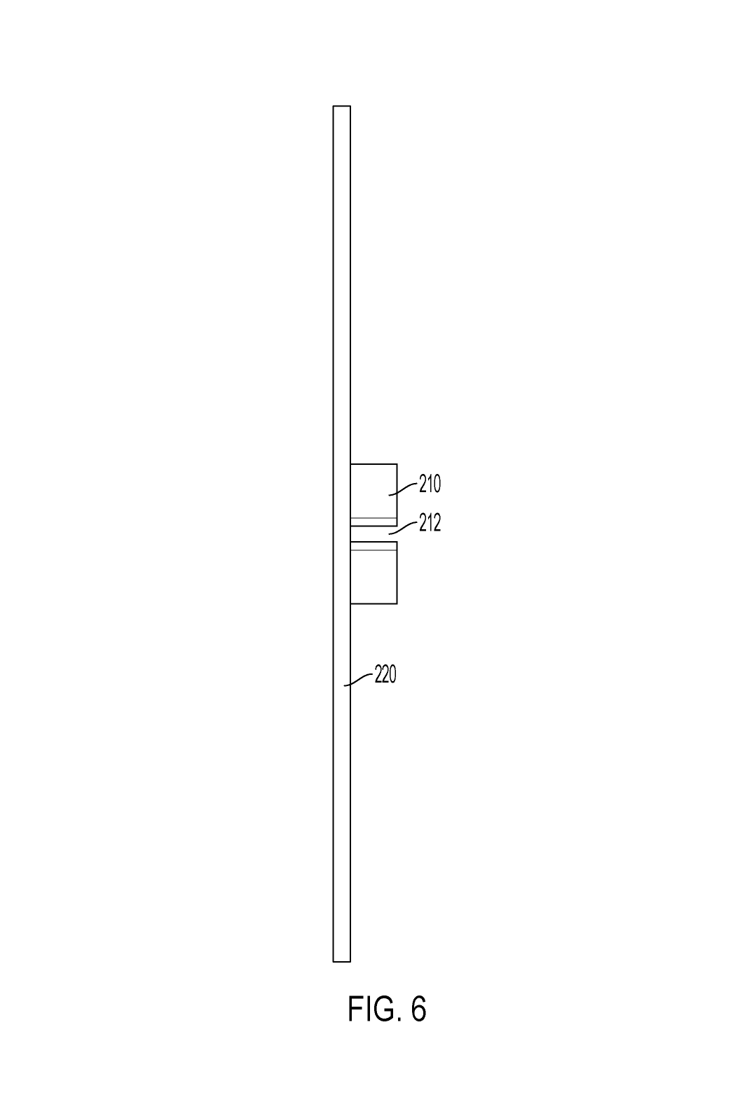

FIG. 6 shows a side view of the cap 200 according to an example embodiment. The center pin 210 has a split 212 in it, creating a push-in fastener. The split 212 allows the pin 210 to be pushed together a small amount, becoming a little bit narrower as it is pushed in, ensuring a secure fit.

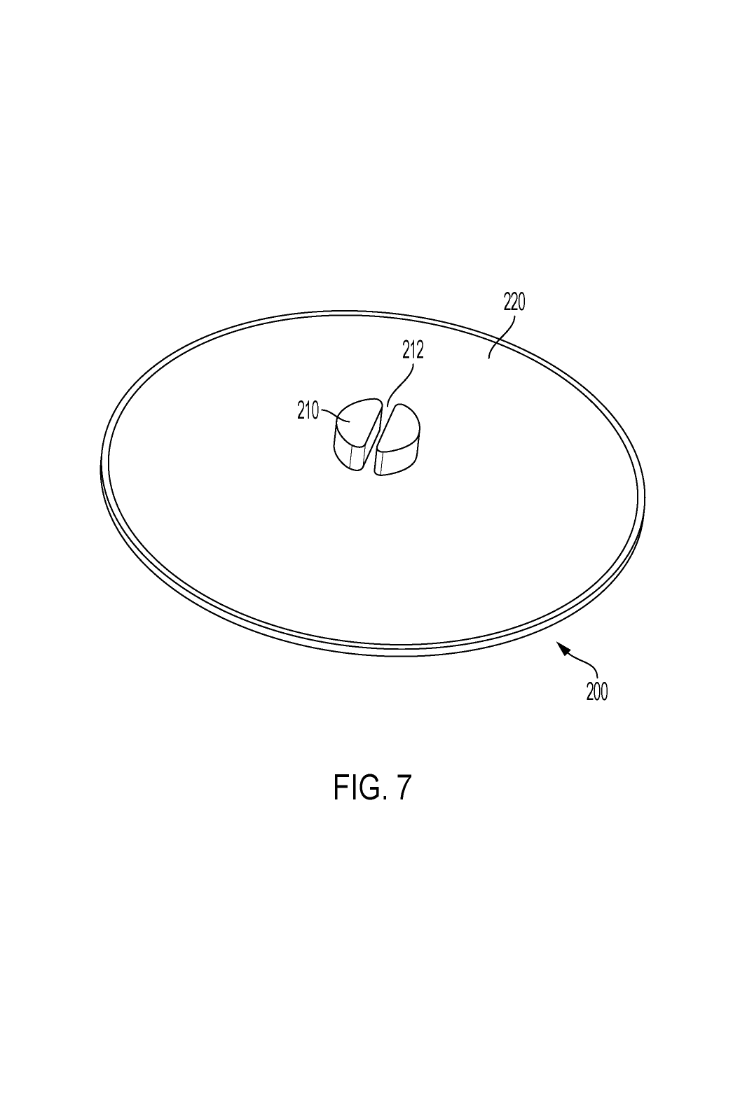

FIG. 7 shows the cap 200 with the disk 220 and push-in fastener 210 at the center, with the split 212 within the fastener 210.

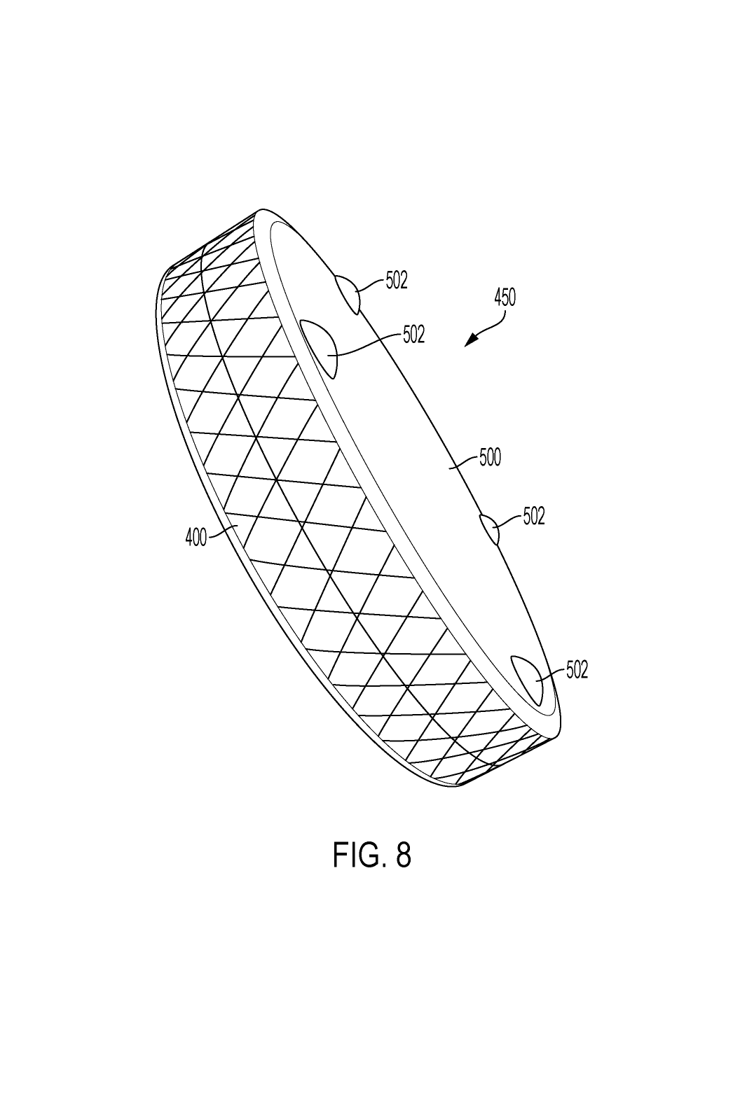

FIG. 8 shows the bottom of base assembly 450 according to an example embodiment. As depicted, the bottom of bottom piece 500 includes feet 502. Feet 502 may be made of a substance that provides traction, such as rubber, to keep the base assembly 450 from slipping while in use.

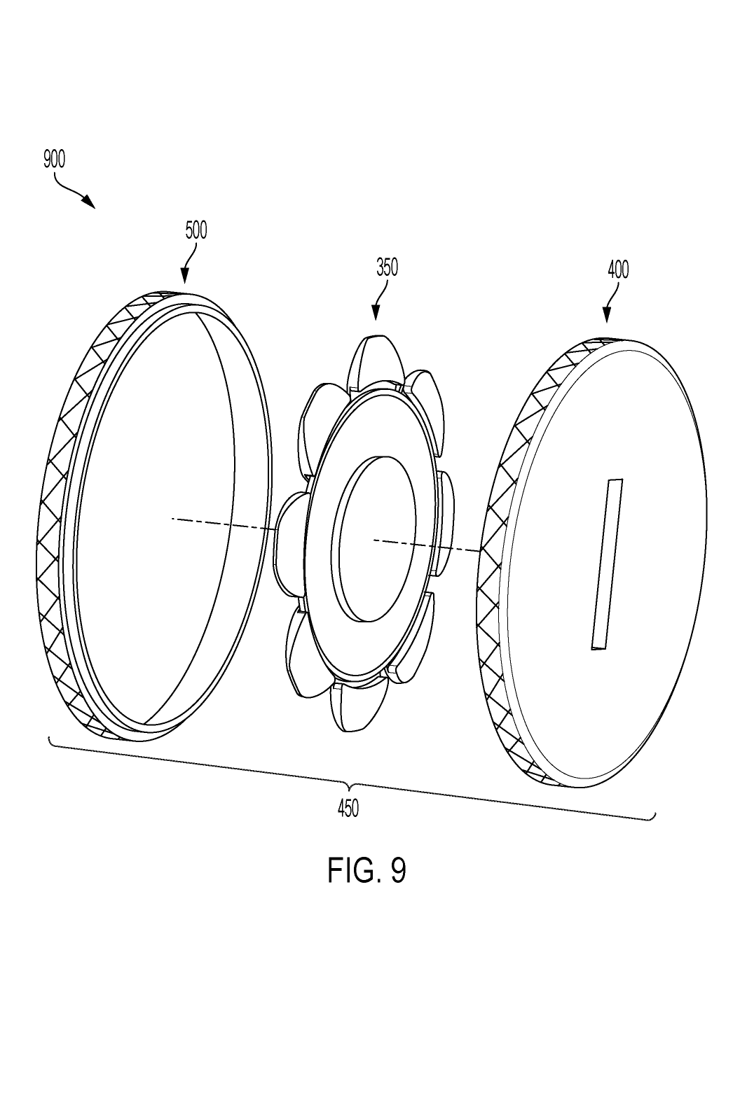

FIG. 9 depicts an exploded view 900 of the blade assembly 350 being placed within base assembly 450 between bottom piece 500 and top piece 400.

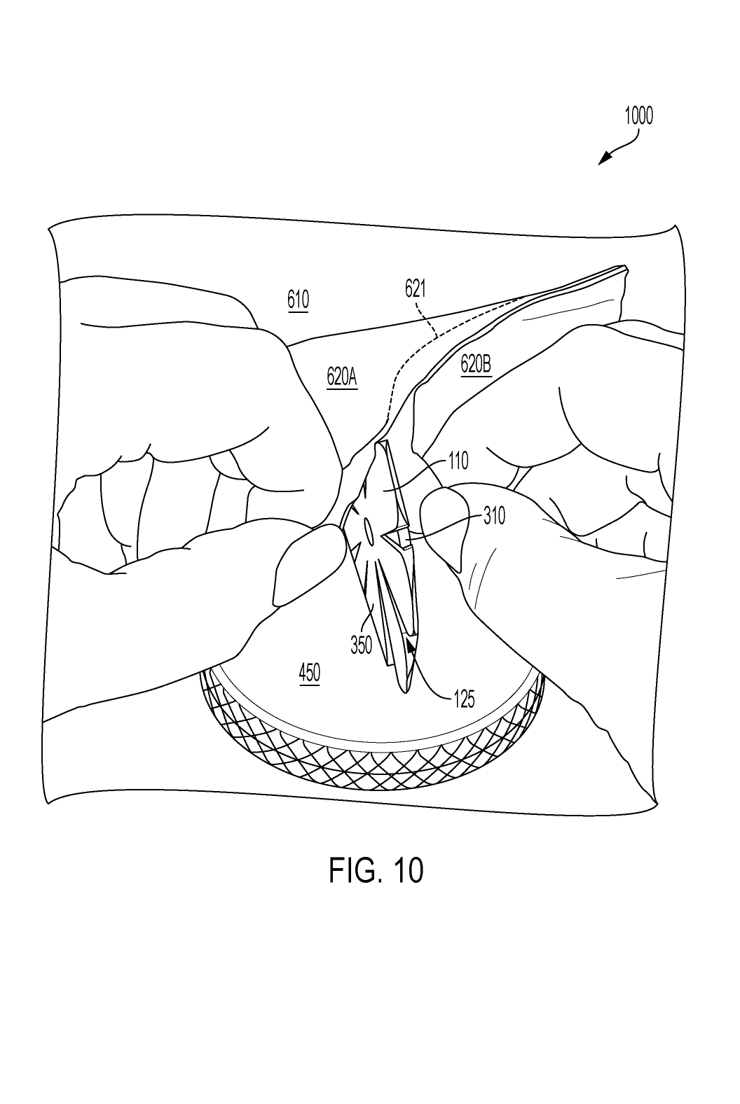

FIG. 10 shows an example view 1000 of the assembled seam ripper in use according to one embodiment. The blade assembly 350 is inserted into the base assembly 450 as also shown in FIG. 5 and set upon a flat surface 610 such as a table. The two sewn together pieces of fabric 620A, 620B are arranged so that the parallel pieces of fabric 620 are divided by the petal 110. As the petal 110 gets wider, it slightly opens seam 621 and moves the fabric 620 away from the blade 300. This positions the seam 621 above the blade 300.

In one embodiment, with the blade assembly 350 positioned vertically in a base assembly 450 on the table 610, the user uses both hands, one on each piece of fabric 620, and pulls the fabric 620 down causing the blade 300 to cut multiple stitches of the seam 621 with each pull.

In such an embodiment the user could take one piece of fabric 620A, 620B in each hand and gently pull in a motion toward the table 610 , and the edge 310 of the blade 300 could then cut through multiple stitches of seam 621 during each pull. Any quilter can tell you the absolute joy of hearing the tick, tick, tick, tick sound of hearing multiple stitches being cut and seeing the fabric pieces 620A, 620B come apart like they were just unzipped.

In the plane of the cutting direction, the fabric 620 can move parallel to the blade 300, with the blade 300 between the two pieces 6220A, 620B As long as the blade 300 and the fabric 620 are parallel, they will never meet. If the fabric 620 begins to approach the blade 300, the narrow gap 125 will cause the fabric 620 to start to wrinkle and bunch prior to approaching the blade 300, providing the user with an instant and noticeable tactile feedback.

In another embodiment, as depicted in view 1100 of FIG. 11, blade assembly 350 is used without being inserted into base assembly 450. The user holds the fabric 620 upright from the top and drags the blade assembly 350 down between the pieces of fabric 620, allowing the exposed portion of the cutting edge 310 of blade 300 within a gap 125 to cut the seam 621. The user can make one swift downward motion to cut several stiches of seam 621 at once.

This apparatus may be created using a 3-D printer, although in a typical embodiment, the blade 300 is produced separately not using a 3-D printer. This seam ripper could be made of a variety of materials including but not limited to plastic, ceramic, or metal.

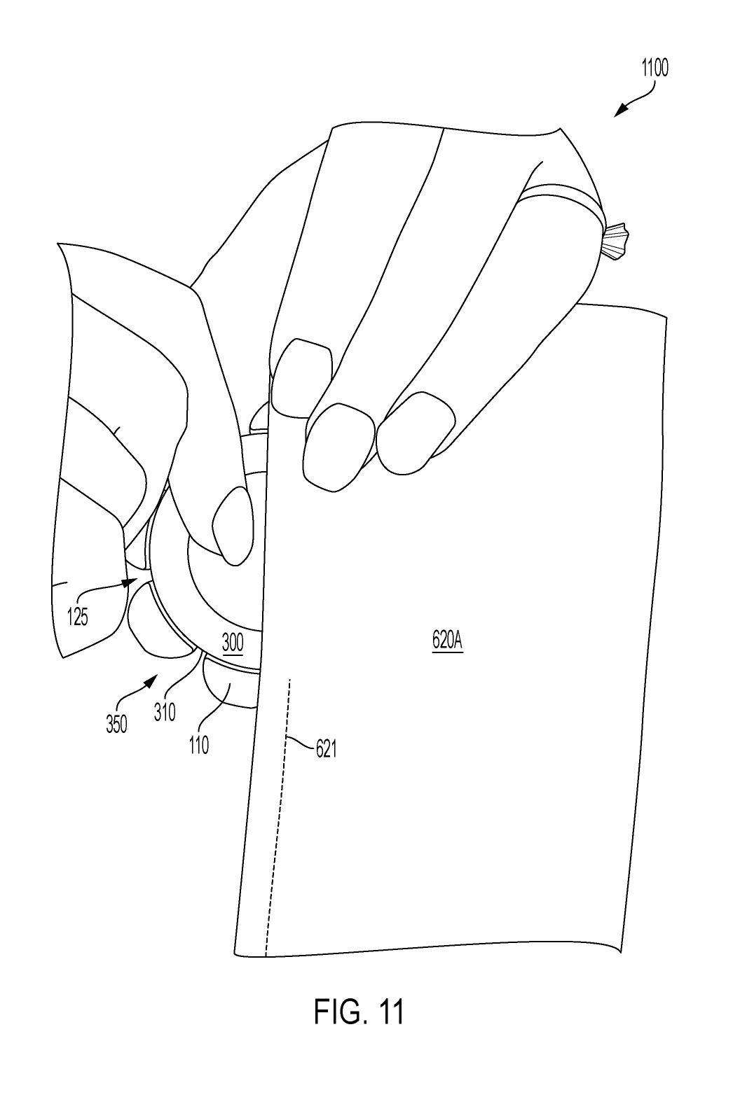

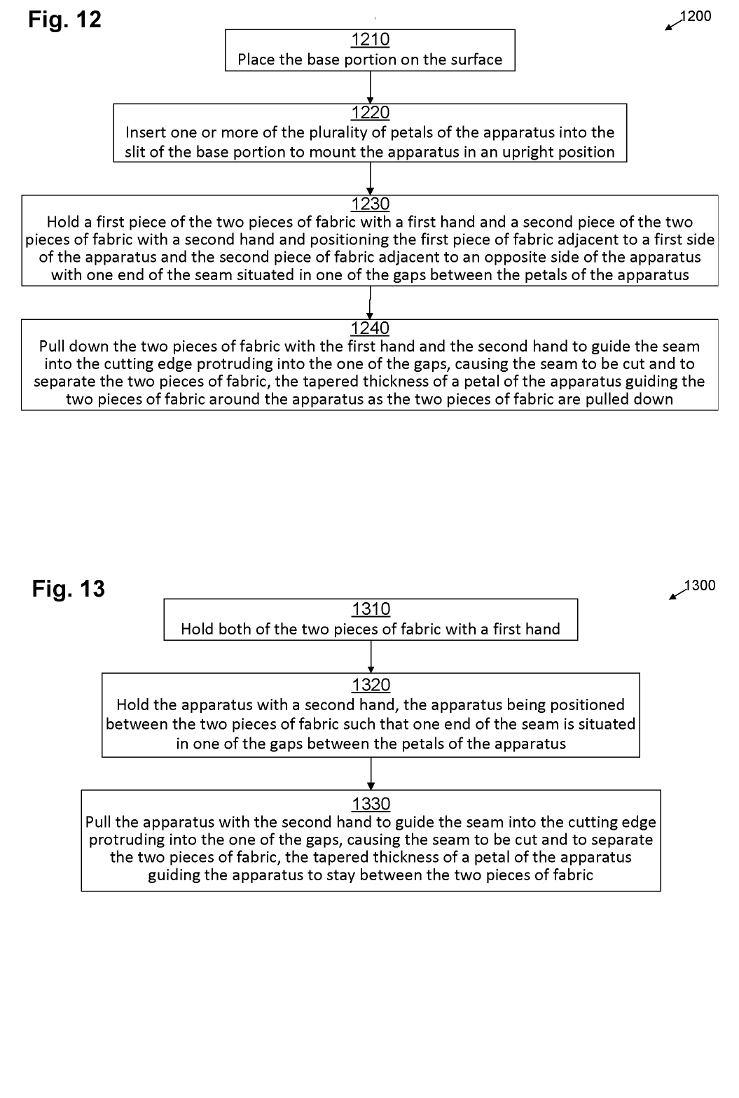

FIG. 12 depicts an example method 1200 of operating the system such as the blade assembly 350 and the base assembly 450 as depicted in FIG. 10. It should be understood that one or more of the steps or sub-steps of method 1200 may be omitted in some embodiments. Similarly, in some embodiments, one or more steps or sub-steps may be combined together or performed in a different order.

In step 1210, a user places the base assembly 450 on the surface 610. In step 1220, the user inserts one or more of the plurality of petals 110 of the blade assembly 350 into the slit 410 of the base assembly 450 to mount the blade assembly 350 in an upright position. The order of steps 1210 and 1220 may be reversed in another embodiment.

In step 1230, the user holds a first piece of fabric 620A with a first hand and a second piece of fabric 620B with a second hand and positions the first piece of fabric 620A adjacent to one side (e.g., next to the back piece 100) of the blade assembly 350 and the second piece of fabric 620B on the other side of the blade assembly 350 (e.g., adjacent to the fastening mechanism, such as cap 200) with one end of the seam 621 situated in one of the gaps 125 between the petals 110 of the blade assembly 350.

In step 1240, the user pulls down the two pieces of fabric 620A, 620B with the first hand and the second hand to guide the seam 621 into the cutting edge 310 protruding into the one of the gaps 125, causing the seam 621 to be cut and to separate the two pieces of fabric 620, the taper 150 of a petal 110 of the blade assembly 350 guiding the two pieces of fabric 620 as the two pieces of fabric 620 are pulled down.

FIG. 13 depicts a method 1300 of operating the a device such as the blade assembly 350 without using the base assembly 450 as depicted in FIG. 11. In step 1310, a user holds both of the two pieces of fabric 620 with a first hand. In step 1320, the user holds the blade assembly 350 with a second hand, the blade assembly 350 being positioned between the two pieces of fabric 620 such that one end of the seam 621 is situated in one of the gaps 125 between the petals 110 of the blade assembly 350. In step 1330, the user pulls the blade assembly 350 with the second hand to guide the seam 621 into the cutting edge 310 protruding into the one of the gaps 125, causing the seam 621 to be cut and to separate the two pieces of fabric 620, the taper 150 of a petal 110 of the blade assembly 350 guiding the blade assembly 350 to stay between the two pieces of fabric 620. It should be understood that an equivalent of step 1330 would be to pull the two pieces of fabric 620 with the first hand towards the blade assembly 350 or to pull with both hands so that both the two pieces of fabric 620 and the blade assembly 350 approach each other.

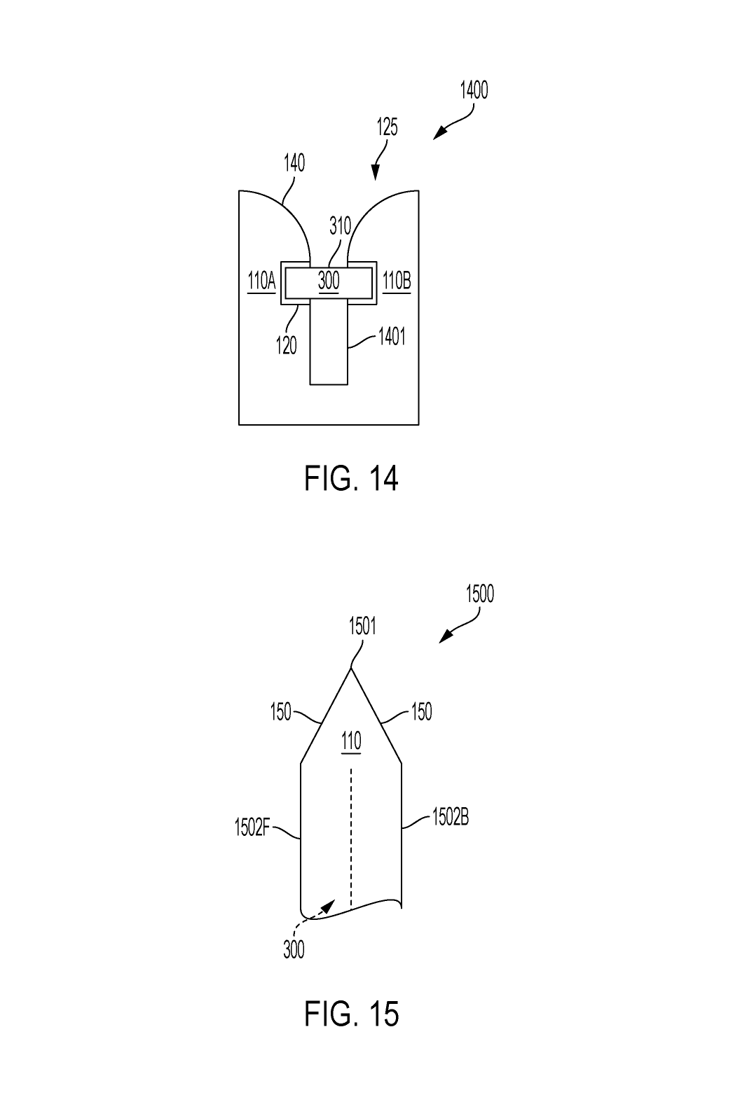

It should be understood that the above description only describes embodiments having a circular flower-like shape, but other embodiments may have different shapes. Thus, as depicted in FIG. 14, an alternate arrangement 1400 of a blade assembly 350 according to another embodiment includes only two petals 110A, 110B arranged substantially parallel to each other with blade 300 having a rectangular shape. In a more generalized embodiment, blade assembly 350 includes at least two petals 110 with a gap 125 between each pair of adjacent petals 110, whether arranged linearly, radially, or in another arrangement. The side walls 1401 of each petal 110 adjacent to the gap 125 near the edge 310 of the blade 300 are substantially perpendicular to the cutting edge 310 of the blade 300. Above the cutting edge 310, the side walls 1401 of each petal 110 may curve away from each other to form the curves 140 of the petals 110. As depicted in FIG. 14, blade 300 sits within indentation 120, which may span across both petals 110A, 110B.

In addition, it should be understood that the above description only describes embodiments having a taper on one side, as depicted in FIG. 3. However, in an alternate embodiment, as depicted in the arrangement 1500 of FIG. 15, the taper 150 of each petal 110 may protrude on both sides of the petal 110, with the blade 300 at the center parallel to a front wall 1502F and a back wall 1502B of the petal 110. FIG. 15 also depicts the top edge 1501 of a petal 110. Although not depicted in FIG. 15, the seam 621 may run along top edge 1501 with one piece of fabric 620A to one side (e.g., adjacent to front wall 1502F) and the other piece of fabric 620B to the other side (e.g., adjacent to back wall 1502B) of the blade assembly 350.

While various embodiments of the invention have been particularly shown and described, it will be understood by those skilled in the art that various changes in form and details may be made therein without departing from the spirit and scope of the invention as defined by the appended claims.

Furthermore, it should be understood that all embodiments which have been described may be combined in all possible combinations with each other, except to the extent that such combinations have been explicitly excluded.

Finally, nothing in this Specification shall be construed as an admission of any sort. Even if a technique, method, apparatus, or other concept is specifically labeled as “background” or as “conventional,” Applicants make no admission that such technique, method, apparatus, or other concept is actually prior art under 35 U.S.C. § 102 or 103, such determination being a legal determination that depends upon many factors, not all of which are known to Applicants at this time.

### TABLE OF REFERENCE CHARACTERS

100 Multi lobed/petaled side of the Blade Holder
110 Petals
120 Indentation where blade sits
125 Gap between petals
130 Hole for the push-in connecter
140 Curve of the petals to direct the fabric
150 Angle on the thickness of the petal, widening the base of the petal to open the seam for cutting.
200 Cap with fastener to keep the blade secure
210 Push-in fastener on the disk
212 Split in push-in fastener
220 Disk to hold the blade in place
300 Blade
310 Cutting Edge of the Blade
320 This is the space between the edge of the disk and the edge of the blade
330 Hole in blade
340 Markings around blade
350 Blade assembly
400 Top of the box which holds the ripper
410 Slit in the top of the box to serve as a stand for the ripper
450 Base assembly (Box)
500 Bottom of the box
502 Feet
510 Knurled edges of the box for easy gripping
610 Surface on which base assembly rests
620A, 620B Pieces of attached fabric
621 Seam connecting the two pieces of fabric
1401 Side wall of a petal facing the gap
1501 Top edge of petal
1502F Front wall of blade assembly
1502B Back wall of blade assembly

What is claimed is:

1. An apparatus comprising:
two tapered petals, each tapered petal having a tapered thickness that increases from a peripheral edge towards an interior point;
a gap between the two tapered petals; and
a blade having a cutting edge that protrudes into the gap;
wherein a side wall of each of the two petals adjacent to the gap is substantially perpendicular to the cutting edge of the blade.

2. The apparatus of claim 1 wherein the side wall of each of the two petals adjacent to the gap is shaped such that the gap widens between the edge of the blade and the peripheral edges of the two petals.

3. The apparatus of claim 2 wherein the side walls of each of the two petals adjacent to the gap curve away from each other, the two tapered petals each having a rounded shape.

4. The apparatus of claim 2 wherein the gap decreases in width beyond the edge of the blade such that the two petals connect to form a single blade holder piece, the blade holder piece including an indentation in which the blade rests.

5. The apparatus of claim 4 wherein the single blade holder piece includes a plurality of more than 2 tapered petals and a plurality of more than 1 gap between adjacent petals, the edge of the blade protruding into each gap.

6. The apparatus of claim 5 wherein:
the single blade holder piece includes a central portion having a substantially circular shape, each of the plurality of more than 2 tapered petals emanating from the central portion having the substantially circular shape;
the blade is a circular blade and the cutting edge is circular around a circumference of the blade; and
the indentation in which the blade rests is circular in shape, situated within the central portion of the single blade holder piece.

7. The apparatus of claim 6 wherein:
the circular blade is fastened to the single blade holder piece such that the circular blade is fixed into place within the indentation; and
the circular blade can be rotated within the indentation with an application of more than a threshold amount of force.

8. The apparatus of claim 7 wherein the circular blade includes a plurality of markings adjacent to its cutting edge to indicate how much the circular blade has been rotated.

9. The apparatus of claim 8 wherein two or more of the plurality of markings are numbered in consecutive order.

10. The apparatus of claim 9 wherein the plurality of markings includes unnumbered markings, one unnumbered marking interposing halfway between each pair of consecutively numbered markings.

11. The apparatus of claim 9 wherein a count of the numbered markings is a natural number multiple of the plurality of gaps.

12. A method of operating the apparatus of claim 7, the method comprising, in response to a portion of the cutting edge of the blade protruding into one of the plurality of gaps becoming dull, applying more than the threshold amount of force to the blade and rotating it such that a sharp portion of the cutting edge is exposed protruding into the one of the plurality of gaps.

13. A system comprising:
the apparatus of claim 6; and
a base portion having a slit into which one or more of the plurality of petals of the apparatus may be inserted;
wherein when one or more of the plurality of petals of the apparatus is inserted into the slit of the base portion and the base portion is resting on a surface, the apparatus is mounted upright within the base portion with respect to the surface.

14. The system of claim 13 wherein the base portion includes a top piece and a bottom piece, the slit being situated in the top piece, the top piece and the bottom piece being separable to allow the apparatus to be stored within a compartment formed from the top piece and the bottom piece once the top piece and the bottom piece are reattached.

15. The system of claim 13 wherein the base portion includes a knurled edge for gripping.

16. The system of claim 13 wherein the base portion includes a plurality of feet made from a substance having traction positioned opposite the slit, allowing the base portion to firmly grip the surface.

17. A method of ripping a seam attaching two pieces of fabric using the system of claim 13, the method comprising:
placing the base portion on the surface;
inserting one or more of the plurality of petals of the apparatus into the slit of the base portion to mount the apparatus in an upright position;
holding a first piece of the two pieces of fabric with a first hand and a second piece of the two pieces of fabric with a second hand and positioning the first piece of fabric adjacent to a first side of the apparatus and the second piece of fabric adjacent to an opposite side of the apparatus with one end of the seam situated in one of the gaps between the petals of the apparatus; and
pulling down the two pieces of fabric with the first hand and the second hand to guide the seam into the cutting edge protruding into the one of the gaps, causing the seam to be cut and to separate the two pieces of fabric, the tapered thickness of a petal of the apparatus guiding the two pieces of fabric around the apparatus as the two pieces of fabric are pulled down.

18. A method of ripping a seam attaching two pieces of fabric using the apparatus of claim 1, the method comprising:
holding both of the two pieces of fabric with a first hand;
holding the apparatus with a second hand, the apparatus being positioned between the two pieces of fabric such that one end of the seam is situated in one of the gaps between the petals of the apparatus; and
pulling the apparatus with the second hand to guide the seam into the cutting edge protruding into the one of the gaps, causing the seam to be cut and to separate the two pieces of fabric, the tapered thickness of a petal of the apparatus guiding the apparatus to stay between the two pieces of fabric.
